(19) United States
(12) Patent Application Publication
(10) Pub. No.: US 2025/0091670 A1
(43) Pub. Date: Mar. 20, 2025

(54) Foot for Legged Robot

(71) Applicant: ANYBOTICS AG, Zürich (CH)

(72) Inventors: Fabian Günther, Bülach (CH); David Sekanina, Zürich (CH); Aravind Elanjimattathil Vijayan, Zürich (CH); Joël Schlienger, Zürich (CH); Ayla Watsuji, Zürich (CH); Alessandro Schiavone Scafato, Schwerzenbach (CH); Robin Verschueren, Zürich (CH)

(21) Appl. No.: 18/729,636

(22) PCT Filed: Feb. 1, 2022
(86) PCT No.: PCT/EP2022/052293

§ 371 Date: Jul. 17, 2024

(51) Int. Cl. B62D 57/032

(52) U.S. Cl. CPC B62D 57/032

(57) ABSTRACT

The invention refers to a robot foot (1001), a robot foot adapter (1002), a robot leg section (1003), a robot leg assembly (1004) and a method for manufacturing the robot foot. The robot foot (1001) comprises a solid body (1) with a surface and an attachment section (13) adapted to mount the robot foot (1001) to a robot or a robot foot adapter (1002). In addition, the robot foot (1001) comprises a foot pad (2). The foot pad (2) comprises an elastomer material. The foot pad (2) covers the first section (11) of the solid body (1) and positively engages in a non-detachable manner with the first section (11) in a direction (d) of a longitudinal axis (100) of the solid body (1).

### TECHNICAL FIELD

The invention relates to a robot foot, in particular for a legged robot, a robot foot adapter, a robot leg section, a robot leg assembly and a method for manufacturing of the robot foot and a use thereof.

### BACKGROUND ART

Legged robots are used for various tasks, in particular for supporting human work in hazardous environments. Usually, a legged robot comprises one or more legs, wherein each leg ends in a foot. Since these robots often work in a harsh environment, the feet of the robots, which are in contact with the environment, are quickly worn off. Typically, a foot of a legged robot comprises a solid body that is at least partially covered with a rubber foot.

For example, document CN214524135U discloses a robot foot end structure of a legged robot. The foot end structure provided by the utility model includes a foot pad mounting seat, an elastic foot pad, and a foot end support member arranged in the elastic foot pad. The foot end support member is fixedly connected with the foot pad mounting seat; the elastic foot pad includes a fastening portion when the foot end support member is fixedly connected to the foot pad mounting seat, the fastening portion is clamped between the foot end support member and the foot pad mounting seat to maintain the fixed connection between the elastic foot pad and the foot pad mounting seat.

The disadvantage of known robot feet is that the elastic foot pad is only clamped to the support member and might fall of easily if the robot walks through a harsh environment.

### DISCLOSURE OF THE INVENTION

The problem to be solved by the present invention is therefore to provide a robust robot foot that allows a legged robot to walk through a harsh environment.

This problem is solved by a first aspect of the invention referring to a robot foot, a second aspect of the invention referring to a robot foot adapter, a third aspect of the invention referring to a robot leg section, a fourth aspect of the invention referring to a robot leg assembly, and a fifth aspect of the invention referring to a method for manufacturing the robot foot.

Unless otherwise stated, the following definitions shall apply in this specification:

The terms “a”, “an”, “the” and similar terms used in the context of the present invention are to be construed to cover both the singular and plural unless otherwise indicated herein or clearly contradicted by the context. Further, the terms “including”, “containing” and “comprising” are used herein in their open, non-limiting sense. The term “containing” shall include both, “comprising” and “consisting of”.

Advantageously, the term “hyperelastic material” refers to a material behaviour for an ideally elastic material or elastomer that can undergo nonlinear elastic deformations. The term is well known to a person skilled in the art. The properties of a vulcanized elastomer can be characterized with a hyperelastic material model. In addition, the hyperelastic material characterization can further be applied to polymers like polyurethane.

Advantageously, the term “non-detachable” refers to a bonding or an adhesion bonding that cannot be easily resolved. In particular, such a bonding might be established by means of adding an adhesion layer or a bonding agent between the non-detachable features.

The first aspect of the invention refers to a robot foot, in particular for a legged robot, very particular for a quadruped robot, comprising a solid body and a foot pad.

The solid body comprises a first section and an attachment section. The first section comprises a surface.

In a further advantageous embodiment, the whole first section can be covered with a metallic surface or the whole first section can consist of a metal. The attachment section is adapted to mount the robot foot to a robot leg, in particular either directly or via a robot foot adapter.

Advantageously, the attachment section allows the robot foot to be mounted to a robot foot adapter or robot leg section or robot. In particular the attachment section is adapted to mount the robot foot to a specific robot model. Therefore, not every robot foot might be mountable to every robot foot adapter or robot leg section. Therefore, by means of the attachment section the robot foot might be easily exchanged by easily unmounting it from the robot foot adapter or robot leg section or robot and replacing it by easily mounting a new robot foot to the respective robot foot adapter, robot leg section or robot.

In a further advantageous embodiment of the invention, the first section and the attachment section both comprises a metallic surface and/or are both made out of metal. In particular the first section and the attachment section form one piece, very particular one metallic piece that is the solid body.

In a further advantageous embodiment, the solid body can have a rotational symmetry shape that extends along a longitudinal axis or can have an asymmetric shape that extends along a longitudinal axis.

The robot foot comprises further a foot pad that comprises a foot material comprising an elastomer. The foot pad covers the surface of the first section and in addition, positively engages with the first section, respectively with the surface, in a non-detachable manner in a direction (d) of the longitudinal axis of the solid body.

Advantageously, the non-detachable robot foot pad is therefore directly attached to the solid body of the robot foot. No clamps are needed to keep the robot foot pad in place due to the form-fitting of the robot foot pad on the first section. Therefore, the solid foot does not need any means for clamping the solid foot pad to it.

Advantageously, the term “elastomer” here refers to natural rubber synthetic elastic polymers. As used herein, the term shall include unsaturated elastomers that can be cured by sulphur vulcanization, saturated elastomers that cannot be cured by sulphur vulcanization and thermoplastic elastomers.

Advantageously, the foot material is a vulcanized elastomer.

In particular, the non-detaching effect of the foot pad is realized by means of the vulcanization of the elastomer. The vulcanization of the elastomer leads to the strong non-detachable effect of the foot pad during the manufacturing of the robot foot.

Advantageously, positive engaging refers to form-fitting. Further advantageously, the foot pad not only positively engages in a direction (d) of the longitudinal axis, but also in a direction perpendicular to the longitudinal axis, and/or in a radial direction, if the solid body is rotational symmetric.

Advantageously, the term cover here refers to a at least partially enclosing of the first section of the solid body with the foot pad, or at least partially encasing the first section with the foot pad, therefore in particular referring to the feature that the foot pad covers or partially encloses the solid body, such that essentially a part of the solid body is covered with the foot pad, in particular the first section is covered with the foot pad. Advantageously, the solid body is completely covered by the foot pad or is partially covered by the foot pad. Further advantageously, the foot pad cover is manufactured by means of injection molding.

In a further advantageous embodiment of the invention, the foot material is selected from the group consisting of NBR, HNBR, SBR, or PUR.

The abbreviations refer to the international abbreviations:
NBR: Nitrile-Butadiene Rubber
HNBR: Hydrogenated Nitrile Rubber
SBR: Styrene Butadiene Rubber
PUR: Polyurethane Rubber

In a further advantageous embodiment of the invention, the foot material is an elastomer with essentially hyperelastic material properties.

In a further advantageous embodiment of the invention, the foot material is conductive. In particular, the feet pad comprising a conductive foot material is adapted to electrically connect a robot leg or other robot components via the solid body of the robot foot to the robot feet pad to the ground.

Advantageously, the conductivity is achieved by means of selecting a conductive elastomer, as defined herein, as a foot material.

Further advantageously, such a conductive elastomer or rubber is characterized using an electrical specific resistivity that is measured and given in Ωcm.

In an advantageous embodiment of the robot foot a specific resistivity between 30 kΩcm and 40 kΩcm, was measured in average using an applied 50V test voltage according to DIN IEC 60093.

Further advantageously, the conductivity of the foot is achieved by means of adding a filler material into an elastomer matrix that is comprised in the foot material. Advantageously, such a filler material might be metallic particles or carbon nanoparticles (carbon black) for examples silver or its alloys, copper or its alloys, nickel or its alloys, graphite doped with Ni, Cu or Ag.

In a further advantageous embodiment of the invention, the foot material is oil-resistant.

Advantageously, oil-resistant refers to an ability of the foot material that makes it perform its intended function while being in contact with an oily or greasy environment. In particular, the foot material comprising HNBR or PUR is highly oil-resistant.

Advantageously, the oil-resistance is qualified according to ISO 1817:2015.

In a further advantageous embodiment of the invention, the non-detachable positive engagement between the in particular metallic surface of the first section and the foot pad is established by means of an adhesion layer arranged between the two, or by means of a bonding agent. In particular the bonding agent is applied by means of spraying it onto the solid body and forming an adhesion layer between the metallic solid body and the foot pad during the injection molding and vulcanization process.

In an advantageous embodiment of the invention, the solid body has an asymmetric shape, such that the form fitting between the solid body and the foot pad is even increased since no rotation of the foot pad around the solid body is possible. In particular, for such an embodiment with an asymmetric shaped solid body, no adhesion layer between the solid body and the food pad is necessary. The foot pad sticks on the solid body because it cannot rotate or otherwise move on the solid body but is totally form-fitting on the solid body in all directions.

Advantageously, the first section is segueing into the attachment section in a direction (d) of a longitudinal axis of the solid body. Further advantageously the foot pad positively engages with the first section in the direction (d) of the longitudinal axis and in particular also in a direction perpendicular to the longitudinal axis.

In a further advantageous embodiment of the invention, the solid body comprises a constriction section, wherein the constriction section is arranged between the first section and the attachment section.

Advantageously, the constriction section is arranged between the first section and the attachment section in a direction of the longitudinal axis (d) of the solid body. The constriction section comprises a constriction with a diameter smaller than the largest diameter of the first section. The foot pad covers at least partially the constriction section and by means of the constriction positively engages with the constriction section in a direction opposite to the direction (d) of the rotational axis.

In a further advantageous embodiment of the invention, the attachment section of the robot foot is adapted to positively engage with the robot, in particular with the robot foot adapter, very particular with a robot leg section. Advantageously, the attachment section positively engages with the robot, in particular the robot foot adapter or the robot leg section in the direction (d) of the longitudinal axis. In a further advantageous embodiment, the attachment section might additionally be adapted to force-lock with the robot, in particular the robot foot adapter, very particular the robot leg section.

In a further advantageous embodiment of the invention, an axial through hole extends in a direction d of the longitudinal axis of the solid body fully through the foot pad and at least partially through the solid body. The through hole is adapted for inserting a screw for force-locking the foot pad with the solid body.

Advantageously, a first section of the through hole has a larger diameter than a second section of the through hole. The trough hole is therefore adapted for a screw to sink into the through hole in the direction d of the longitudinal axis until the head of the screw stops at the smaller diameter of the second section of the through hole.

In a further advantageous embodiment, the screw hole might be formed as a countersink.

In a further advantageous embodiment of the invention, the attachment section comprises a non-rotatable form-fitting nut or protrusion. The nut or protrusion is arranged in a plane perpendicular to the longitudinal axis of the solid body and is adapted to engage with a counterpart arranged on the robot, on the robot leg, or on the robot leg adapter. Advantageously, the nut or protrusion is rectangular with corner fillets or oval shaped.

A further advantageous embodiment of the invention comprises the solid body comprising at least one bore to reduce the weight of the solid body.

Advantageously, a longitudinal axis of the at least one bore is
arranged co-axial to the longitudinal axis of the solid body, and
extends from a surface of the attachment section that is facing away from the first section, in a direction opposite of the direction d of the longitudinal axis into the solid body.

Further advantageously, up to six bores are equally arranged around the longitudinal axis and are. arranged parallel to the longitudinal axis, and
extending from said surface of the attachment section, in the direction opposite of the direction d of the longitudinal axis into the solid body.

A second aspect of the invention refers to a robot foot adapter. The robot foot adapter is adapted to mount the robot foot according to the first aspect to a robot leg section.

The robot foot adapter comprises an adapter longitudinal axis. A first end of the robot foot adapter is adapted to positively engage with the attachment section of the robot foot.

Advantageously, the first end is formed in a way that in the intended use of the robot foot adapter, the first end positively engages with the attachment section of the robot foot. Advantageously the positive engagement is such that the adapter longitudinal axis is not coaxial with the longitudinal axis of the robot foot.

This means, that there is an angle α between the adapter longitudinal axis and the longitudinal axis of the robot foot, wherein α is 0°≤α≤30°.

In a further advantageous embodiment of the invention, the robot food adapter comprises a bore that is adapted to receive a screw that penetrates the robot foot (in particular the robot foot that comprises a through hole) along its full longitudinal axis, adapted to mount the robot foot adapter to the robot foot.

A further advantageous embodiment of the robot foot adapter comprises an electrical connection between the first end and a second end of the robot foot adapter. Advantageously, the first end is adapted to electrically connect with the robot foot. Further advantageously, the second end is adapted to electrically connect with the robot leg section.

Further advantageously, an outer surface of the robot foot adapter is electrically insulating between the first end and the second end of the robot foot adapter. Advantageously, the robot foot adapter has an anodized outer surface.

Advantageously, the outer surface refers to the surface surrounding the robot foot adapter, wherein the outer surface might be the full outer surface between the first and the second end or only part of the outer surface between the first and the second end of the robot foot adapter.

Therefore, in an advantageous embodiment of the robot foot adapter, the robot foot can be insulating at the outer surface but might have a first end and a second end that are electrically connected via a conductive core material of the foot adapter.

In a further advantageous embodiment of the invention, the robot foot adapter is entirely anodized at the outer surface, except at the first end and at the second end. In particular, the second end comprises a tube section adapted to glue the robot foot adapter to a robot leg section or to a robot. In such an embodiment, the electrical connection between the first end and the second end goes between the first end that is not anodized and therefore conductive through the core metallic body to the second end that is not anodized and therefore conductive.

Further advantageously, the second end of the robot foot adapter, that is advantageously adapted to connect to a robot leg section, comprises a rim that is connective at the outer surface, for electrically connecting to the robot leg section.

In addition, in a further advantageous embodiment of the robot foot adapter, the robot foot adapter comprises conductive O-rings adapted to be seated in a groove at the first and/or second end of the adapter and electrically connecting the robot foot adapter with the robot foot at the first end and/or with a robot leg section at the second end.

A third aspect of the invention refers to a robot leg section. The robot leg section comprises a first end adapted to receive the robot foot adapter according to the second aspect and a second end adapted to be mounted to a further leg section or robot.

An advantageous embodiment of the robot leg section has a first end and a second end that are electrically interconnected. The first end of the robot leg section is advantageously adapted to electrically connect with the robot foot adapter according to the second aspect. The second end is advantageously adapted to electrically connect with a further robot leg section or the robot.

Advantageously, the electrical connection between the first end and the second end is adapted to electrically connect the robot or further robot leg section.

In a further advantageous embodiment of the robot leg section, an outer surface of the robot leg section is insulating, in particular the outer surface of the robot leg section is an anodized surface.

Advantageously, the outer surface refers to the surface surrounding the robot leg section, wherein the outer surface might be the full outer surface between the first and the second end or only part of the outer surface between the first and the second end of the robot leg section.

A fourth aspect of the invention refers to a robot leg assembly comprising a robot foot according to the first aspect, a robot foot adapter according to the second aspect and a robot leg section according to the third aspect of the invention.

Advantageously, the robot leg, the robot foot adapter and/or the robot leg section are electrically interconnected.

A fifth aspect of the invention refers to a method for manufacturing the robot foot. The method comprises the steps:
providing the solid body with an in particular metallic surface,
advantageously at least partially, advantageously fully, coating the in particular metallic surface with an adhesion promoter,
providing a foot material made of an elastomer to form the feet pad, and
molding or injection molding the feet pad from said material onto the coated in particular metallic surface.

A further advantageous step of the method is to mold or injection mold the feet pad from the elastomer material by means of vulcanization, wherein this works only for materials that can be vulcanized.

Advantageously, the adhesion promoter might be applied onto the full surface of the first section or might be applied onto parts of the surface of the first section or might be applied to more than 50% of the surface of the first section. In addition, the adhesion promoter might further be applied to the constriction section if there is any, in particular partially over the surface area of the constriction section or over the full surface area of the constriction section.

Further advantageously, the foot pad is manufactured by means of injection molding. Injection molding refers to a process wherein a metallic insert, the solid body with the in particular metallic surface, is placed into a mold and by means of injection molding is encapsulated in the foot material.

In a further aspect of the invention, the robot foot is a product that comprises a solid body with first section comprising an in particular metallic surface and an attachment section. In addition, the robot foot comprises a robot foot pad comprising a foot material comprising an elastomer. The product is obtained by the steps of injection molding of the foot pad, respectively the elastomer around the first section and subsequent vulcanization of the foot pad respectively the elastomer. Further advantageously, an adhesion promoter is added before the injection molding step.

A sixth aspect of the invention refers to a use of a robot foot according to the first aspect of the invention.

A seventh aspect of the invention refers to a use of a robot foot adapter according to the second aspect of the invention.

A eighth aspect of the invention refers to a use of a robot leg section according to a third aspect of the invention.

A ninth aspect of the invention refers to a use of a robot leg assembly according to a fourth aspect of the invention.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1a) to 1f) show different views and section views of a schematic of a robot foot comprising a solid body and a foot pad, according to an embodiment of the invention;

FIGS. 2a) to 2d) show different views and section views of a schematic of a solid body according to an embodiment of the invention;

FIGS. 3a) to 3d) show different views and section views of a schematic of a robot foot adapter according to an embodiment of the invention; and

FIGS. 4a) to 4d) show different views and section views of a robot leg assembly according to an embodiment of the invention.

### MODES FOR CARRYING OUT THE INVENTION

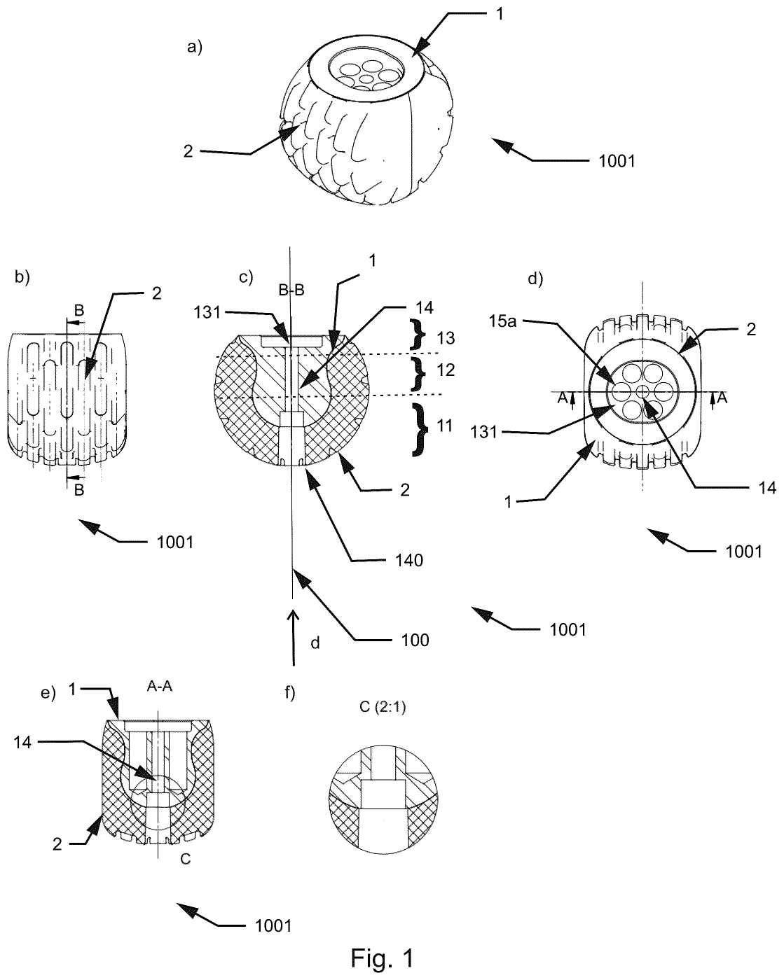

FIG. 1a) shows a schematic of a robot foot (1001), in particular for a legged robot, comprising a solid body (1) and a foot pad (2). The solid body (1) comprises a first section (11) with an in particular metallic surface and an attachment section (13) adapted to mount the robot foot (1001) to a robot. In particular, the attachment section (13) is adapted to mount the robot foot (1001) to a robot foot adapter (1002) and/or to a robot leg (1003). The foot pad (2) comprises a foot material made of an elastomer. Additionally, the foot pad covers the first section (11) and positively engages with the first section (11) in a non-detachable manner in a direction of a longitudinal axis (100) of the solid body.

In a further advantageous embodiment of the robot foot (1001), an adhesion layer is arranged between the foot pad (2) and the in particular metallic surface of the solid body (1).

Further advantageously, the foot material as shown in FIG. 1a is a material selected from the list consisting of NBR, HNBR, SBR, and PUR, very advantageously of HNBR or PUR. HNBR and PUR are highly oil resistant.

In addition, the foot material is advantageously oil-resistant.

Further advantageously, the foot material of the foot pad (2) is a conductive rubber.

FIG. 1b) shows a front view of the embodiment of the robot foot (1001) of FIG. 1a).

FIG. 1c) shows an advantageous embodiment of a cross section B-B of FIG. 1b). The advantageous embodiment of the solid body (1) comprises a constriction section (12). The constriction section (12) is advantageously arranged between the first section (11) and the attachment section (13). The constriction section (12) comprises a constriction (120) with a diameter smaller than the largest diameter of the first section (11). The foot pad (2) covers at least partially the constriction section (12). By means of the constriction (120), the foot pad (2) positively engages with the constriction section (12) in a direction opposite to the direction (d) of the longitudinal axis (100).

FIG. 1d) shows an advantageous embodiment of a top view of the robot foot (1001). In particular FIG. 1d) shows the top view on the attachment section (13), wherein it is visible how the attachment section (13) is adapted to positively engage with a robot, in particular with a robot foot adapter (1002) and/or a robot leg, in a direction (d) of the longitudinal axis (100).

FIG. 1e) shows an advantageous embodiment of a cross section view A-A of the robot foot (1001) as shown in FIG. 1d). The embodiment of the robot foot (1001) as shown in FIG. 1d) comprises an axial through hole (14) extending in the direction (d) of the longitudinal axis fully through the foot pad (2) and at least partially through the solid body (1). The through hole (14) is adapted for inserting a screw for force-locking the foot pad with the solid body.

The robot foot (1001) is manufactured by a method comprising the following steps:
providing the solid body (1) with an in particular metallic surface,
at least partially coating the in particular metallic surface with an adhesion promoter,
providing a foot material comprising an elastomer material to form the feet pad (2), and. molding the feet pad (2) from said material onto the coated in particular metallic surface.

Advantageously, the material is molded onto the coated in particular metallic surface by means of vulcanization.

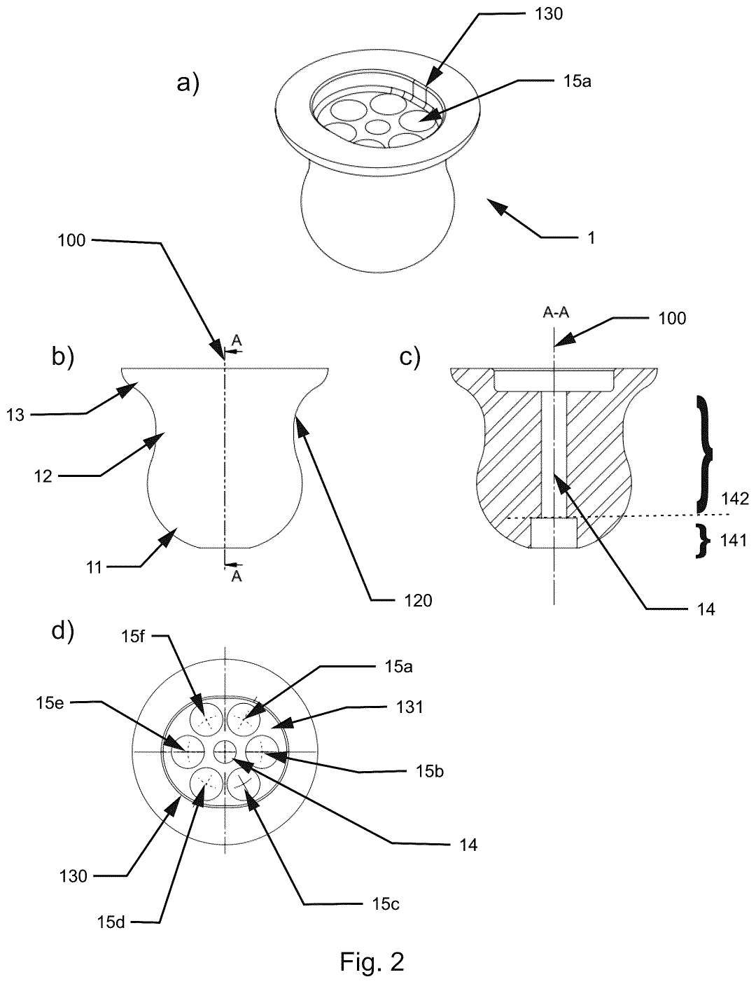

Further advantageous details of the bore are shown in the section view in FIG. 1f) and will be further discussed in regard of FIGS. 2a) to 2d).

FIG. 2a) shows a schematic view of a solid body (1) according to an advantageous embodiment of the invention.

FIG. 2b) shows a side view of the solid body (1) as shown in FIG. 2a). The solid body (1) in this advantageous embodiment comprises in addition to the first section (11) and the attachment section (13) also a constriction section (12) with a constriction (120).

FIG. 2c) shows an advantageous sectional view of FIG. 2b) along the section line A-A. The advantageous solid body (1) comprises a through hole (14) that extends fully through the solid body (1) in the direction (d) of the longitudinal axis (100).

Advantageously, a first section (141) of the through hole (14) has a larger diameter than a second section (142) of the through hole. The through hole (14) is therefore adapted for the screw to sink into the through hole in the direction (d) of the longitudinal axis (100) until the head of the screw stops at the smaller diameter of the second section (142) of the through hole (14).

FIG. 2d) shows an advantageous top view of an advantageous attachment section (13) of the solid body (1). The attachment section (13) comprises a non-rotatable form-fitting nut (130) that is arranged in a plane perpendicular to the longitudinal axis (100). The nut (130) is adapted to engage with a counterpart on the robot, in particular on the robot foot adapter (1002). Advantageously, the nut (130) is rectangular with corner fillets or oval shaped.

In a further advantageous embodiment of the robot that is not shown in this figure, the nut might also be a protrusion with the same properties.

In a further advantageous embodiment of the solid body (1) of the robot foot (1001), the solid body (1) comprises at least one bore (15a) for reducing the weight of the solid body (1). In particular FIG. 1d) and FIG. 2d) show a top view of the solid body (1) wherein the at least one bore (15a) is visible.

In a further advantageous embodiment of the solid body, as shown in FIGS. 1d) and 2d), the longitudinal axis of the at least one bore (15a) is arranged co-axial to the longitudinal axis (100) of the solid body (1). In addition, the longitudinal axis of the at least one bore (15a) extends from a surface (131) of the attachment section (13) that is facing away from the first section (11), in a direction opposite of the direction (d) of the longitudinal axis into the solid body (1).

Further advantageously, up to six bores (15a, 15b, 15c, 15d, 15e, 15f) are equally arranged around the through hole (14) and parallel to the longitudinal axis (100). In addition, the up to six bores (15a, 15b, 15c, 15d, 15e, 15f) extend from said surface (131) of the attachment section (13) into a direction co-axial to the longitudinal axis (100) of the solid body (1).

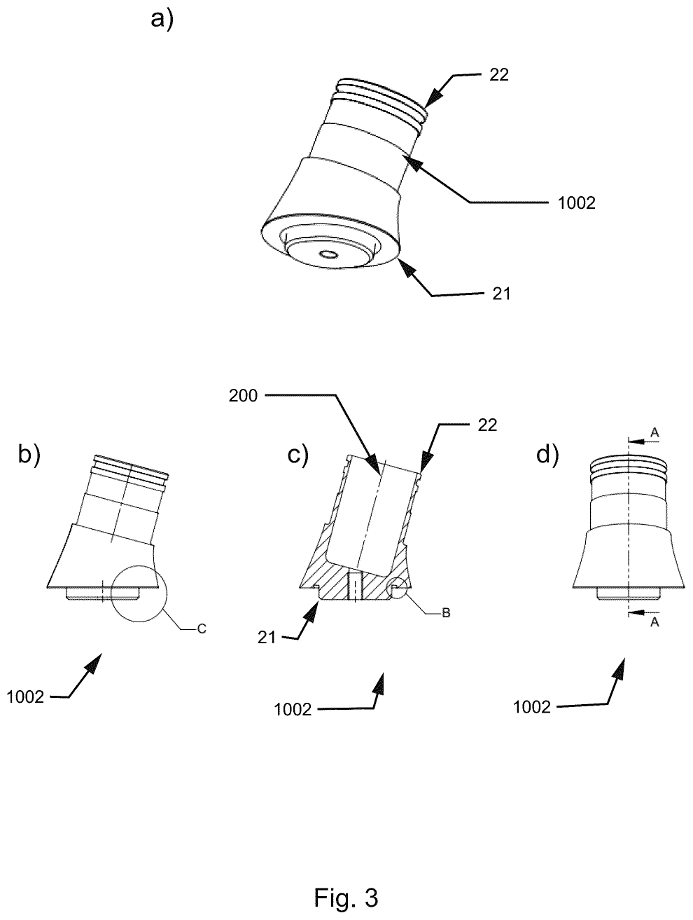

FIG. 3a) shows a schematic view of an advantageous embodiment of a robot foot adapter (1002). The robot food adapter (1002) is adapted to mount the robot foot (1001) to a robot leg section (1003).

FIG. 3a) shows a side view of the advantageous robot foot adapter (1002) and FIG. 3b) a cross section of the adapter (1002).

As shown in FIG. 3c), an advantageous embodiment of the robot foot adapter (1002) comprises a longitudinal adapter axis (200). A first end (21) of foot adapter (1002) is adapted to positively engage with the attachment section (13) of the robot foot (1001). Advantageously, the first end (21) is formed in a way that in the intended use of the robot foot adapter (1002), the first end (21) positively engages with the attachment section (13) of the robot foot (1001). In addition, if the robot foot adapter (1002) is positively engaged with the attachment section (13) of the robot foot (1001), the longitudinal adapter axis (200) of the robot foot adapter (1002) is not co-axial with the longitudinal axis (100) of the robot foot (1001), but might form an angle α between the longitudinal axis (100) of the robot foot and the adapter longitudinal axis (200).

In a further advantageous embodiment of the robot foot adapter (1002), the robot foot adapter (1002) comprises a bore that is adapted to receive a screw that penetrates the robot foot (1001) along its full longitudinal axis (100), for mounting the robot foot adapter (1002) to the robot foot (1001).

FIG. 3d) shows a side view of the robot foot adapter (1002).

In a further advantageous embodiment of the robot foot adapter (1002), there is an electrical connection between the first end (21) and the second end (22) of the robot foot adapter (1002). Advantageously, the first end (21) is adapted to electrically connect with the robot foot (1001). Further advantageously, the second end (22) is adapted to electrically connect with the robot leg section (1003).

In a further advantageous embodiment of the invention, the robot foot adapter (1002) is entirely anodized at the outer surface, except the first end (21) and the second end (22), in particular, wherein the second end (22) comprises a tube section adapted to glue the robot foot adapter (1002) to a robot leg section (1003) or to a robot. In such an embodiment, the electrical connection between the first end (21) and the second end (22) goes between the first end (21) that is not anodized and therefore conductive through the core metallic body to the second end (22) that is not anodized and therefore conductive.

In a further advantageous embodiment of the robot foot adapter (1002), the robot foot adapter (1002) comprises conductive O-rings adapted to be seated in a groove at the first (21) and/or second (22) end of the adapter (1002).

In particular, the first end (21) and the second end (22) are electrically connecting the robot foot adapter (1002) with the robot foot (1001) at the first end (21) and/or with a robot leg section (1003) at the second end (22).

Further advantageously, the electrical connection between the robot foot (1001) and the robot foot adapter (1002) is realized by means of a screw penetrating the through hole (14) of the conductive solid body (1) and further penetrates the robot foot adapter (1002), for screwing, force-fitting and electrically connecting the robot foot (1001) to the robot foot adapter (1002).

Advantageously, an outer surface of the robot foot adapter (1002) is electrically insulating between the first end (21) and the second end (22) of the adapter. In particular, the robot foot adapter (1002) comprises an anodized outer surface.

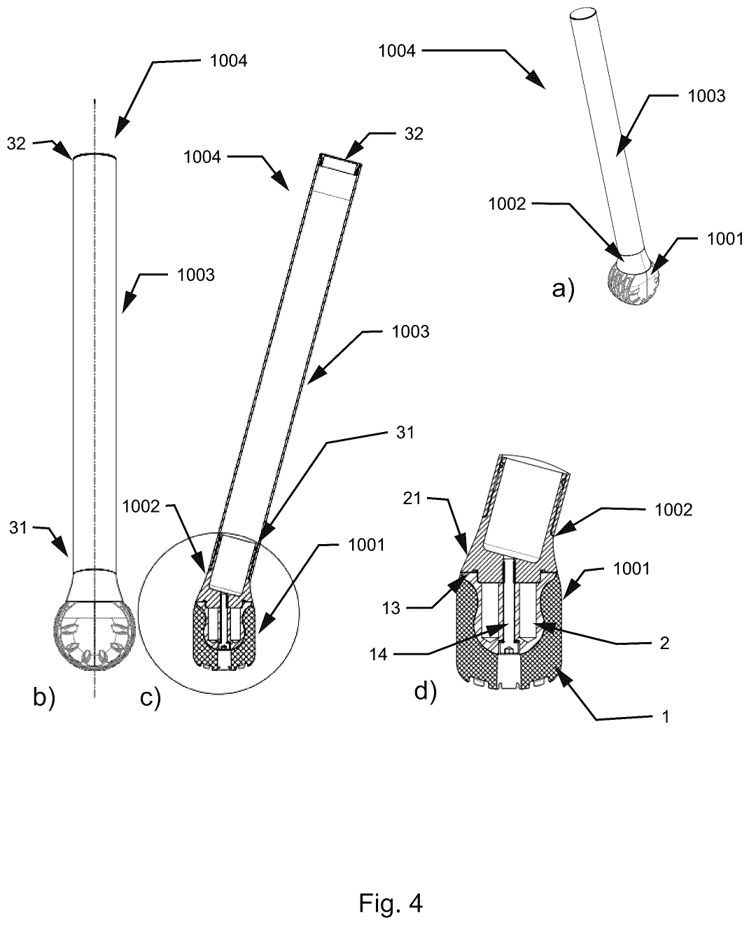

FIGS. 4a) to 4d) shows an embodiment of a robot leg assembly (1004) of the robot foot (1001) with the robot foot adapter (1002) and the robot leg section (1003).

In a further advantageous embodiment of the robot leg assembly (1004), the robot foot (1001), the robot foot adapter (1002) and the robot leg section (1003) are electrically interconnected.

Advantageously, the robot leg section (1003) comprises a first end (31) and a second end (32) which are electrically connected. The first end (31) is adapted to electrically connect with the robot foot adapter (1002) and/or the second end (32) is adapted to electrically connect with a further robot leg section or the robot.

Further advantageously, the robot leg section (1003) comprises conductive O-rings seated in a groove at the first end (31) and/or at the second end (32) of the leg section (1003). The O-rings are adapted to electrically connect the robot leg section (1003) with the robot foot adapter (1002) at the first end (31) and/or the robot at the second end (32).

Further advantageously, an outer surface of the robot leg section (1003) is insulating between the first end (31) and the second end (32) of the robot leg section (1003), in particular, wherein the outer surface of the robot leg section (1003) is anodized.

The section view in FIG. 4d) shows the positive interlocking between the attachment section (13) of the robot foot (1001) and the first end (21) of the robot foot adapter (1002). A screw penetrating the through hole (14) of the solid body (1) also penetrates the robot foot adapter (1002), for force-fitting the robot foot (1001) to the robot foot adapter (1002).

Advantageously, the robot leg section (1003) comprises an electrical connection between a first end (21) of the robot foot adapter (1002) and the attachment section (13) of the robot foot (1001).

### Reference Table

1 Solid body
100 Longitudinal axis
1001 Robot foot
1002 Robot foot adapter
1003 Robot leg section
1004 Robot leg assembly
11 First section
12 Constriction section
120 Constriction
13 Attachment section
130 Asymmetric nut
131 Surface of the attachment section
14 Through hole
141 First section of through hole
142 Second section of through hole
15a At least one bore
15a, 15b, 15c, 15d, 15e, 15f six bores
2 Foot pad
21 First end of robot foot adapter
22 Second end of robot foot adapter
200 Longitudinal axis of foot adapter body
31 First end of robot leg section
32 Second end of robot leg section
d Direction of the longitudinal axis of the robot foot
1-31. (canceled)

32. A robot foot for a legged robot, the robot foot comprising a solid body comprising:
a first section with a surface, and
an attachment section adapted to mount the robot foot to a robot foot adapter of
a robot, and
a foot pad comprising a foot material comprising an elastomer,
wherein the foot pad covers the surface of the first section and positively engages in a non-detachable manner with the first section in a direction of a longitudinal axis of the solid body.

33. The robot foot according to claim 32, wherein the foot material (a) is selected from the group consisting of the classes NBR, HNBR, SBR or PUR, (b) comprises a vulcanized elastomer, (c) comprises an elastomer with essentially hyperelastic material properties, (d) is conductive, and/or (e) is oil-resistant.

34. The robot foot according to claim 32, wherein the solid body comprises a metallic surface.

35. The robot foot according to claim 34, comprising an adhesion layer between the foot pad and the metallic surface of the solid body.

36. The robot foot according to claim 32, wherein the solid body comprises a constriction section, wherein the constriction section is arranged between the first section and the attachment section,
wherein the constriction section comprises a constriction with a diameter smaller than the largest diameter of the first section,
wherein the foot pad covers at least partially the constriction section and by means of the constriction positively engages with the constriction section in a direction opposite to the direction of the longitudinal axis.

37. The robot foot according to claim 32, wherein the attachment section is adapted to positively engage with a robot foot adapter of a robot, in the direction of the longitudinal axis.

38. The robot foot according to claim 32, comprising an axial through hole extending in the direction of the longitudinal axis fully through the foot pad and at least partially through the solid body adapted for inserting a screw for force-locking the foot pad with the solid body.

39. The robot foot according to claim 38, wherein a first section of the through hole has a larger diameter than a second section of the through hole,
adapted for the screw to sink into the through hole in the direction of the longitudinal axis until the head of the screw stops at the smaller diameter of the second section of the through hole.

40. The robot foot according to claim 32, wherein the attachment section comprises a non-rotatable form-fitting nut or protrusion arranged in a plane perpendicular to the longitudinal axis and adapted to engage with a counterpart on the robot foot adapter of the robot,
wherein the nut or protrusion is rectangular with corner fillets or oval shaped.

41. The robot foot according to claim 32, wherein the solid body comprises at least one bore for reducing the weight of the solid body,
wherein a longitudinal axis of the at least one bore is.
arranged co-axial to the longitudinal axis of the solid body, and
extending from a surface of the attachment section that is facing away from the first section, in a direction opposite of the direction of the longitudinal axis into the solid body,
wherein up to six bores are
equally arranged around the longitudinal axis and parallel to the longitudinal axis of the solid body, and
extending from said surface of the attachment section in a direction opposite of the direction of the longitudinal axis into the solid body.

42. A robot foot adapter for mounting the robot foot according to claim 1 to a robot leg section, the robot foot adapter comprising a longitudinal adapter axis extending along the robot foot adapter,
wherein a first end of the robot foot adapter is adapted to positively engage with the attachment section of the robot foot.

43. The robot foot adapter according to claim 42, wherein the longitudinal adapter axis is not coaxial with the longitudinal axis of the robot foot,
wherein an angle α between the adapter longitudinal axis and the longitudinal axis of the robot foot, wherein 0°≤α≤30°.

44. The robot foot adapter according to claim 42, wherein the outer surface of the robot foot adapter is insulating and anodized, essentially in its entirety, except at the first end and at a second end,
wherein the second end comprises a tube section adapted to glue the robot foot adapter to a robot leg section or robot,
wherein a conductive solid body of the robot foot adapter provides an electrical connection between the conductive first end and the conductive second end of the robot foot adapter.

45. The robot foot adapter according to claim 42, comprising a bore adapted to receive a screw that penetrates the robot foot along its full longitudinal axis for mounting the robot foot adapter to said robot foot wherein the robot foot comprises an axial through hole extending in the direction of the longitudinal axis fully through the foot pad and at least partially through the solid body adapted for inserting the screw for force-locking the foot pad with the solid body.

46. The robot foot adapter according to claim 42, comprising an electrical connection between the first end and a second end,
wherein the first end is adapted to electrically connect with the robot foot, and/or
wherein the second end is adapted to electrically connect with the robot leg section.

47. The robot foot adapter according to claim 42, wherein an outer surface between the first end and the second end of the robot foot adapter is electrically insulating, wherein the robot foot adapter has an anodized outer surface.

48. A robot leg section comprising:
a first end adapted to receive the robot foot adapter according to claim 42, and
a second end adapted to be mounted to a further robot leg section or a robot,
wherein the first end and the second end are electrically connected, and wherein
the first end is adapted to electrically connect with the robot foot adapter, and/or.
the second end is adapted to electrically connect with a further robot leg section or the robot.

49. The robot leg section according to claim 48, wherein an outer surface of the robot leg section is insulating, in particular wherein the outer surface of the robot leg section is an anodized surface.

50. A robot leg assembly comprising:
a robot foot, comprising:
a solid body comprising:
a first section with a surface, and
an attachment section adapted to mount the robot foot to a robot, and
a foot pad comprising a foot material comprising an elastomer, wherein the foot pad covers the surface of the first section and positively engages in a non-detachable manner with the first section in a direction of a longitudinal axis of the solid body;
a robot foot adapter for mounting the robot foot to a robot leg section, the robot foot adapter comprising a longitudinal adapter axis extending along the robot foot adapter,
wherein a first end of the robot foot adapter is adapted to positively engage with the attachment section of the robot foot; and
a robot leg section comprising
a first end adapted to receive the robot foot adapter, and
a second end adapted to be mounted to a further robot leg section or a robot,
wherein the first end and the second end are electrically connected, and wherein
the first end is adapted to electrically connect with the robot foot adapter, and/or
the second end is adapted to electrically connect with a further robot leg section or the robot.

51. The robot leg assembly according to claim 50, wherein the robot foot, the robot foot adapter and/or the robot leg section are electrically connected.

52. A method for manufacturing the robot foot according to claim 32, comprising:
providing the solid body with a surface,
providing an elastomer material to form the feet pad, and
molding the feet pad from the elastomer material onto the coated metallic surface.

53. The method according to claim 52, wherein the solid body comprises a metallic surface,
wherein the method comprises at least partially coating the metallic surface with an adhesion promoter.

54. The method according to claim 52, wherein the elastomer material is molded onto the coated metallic surface by means of vulcanization.
